(19) United States
(12) Patent Application Publication
(10) Pub. No.: US 2008/0054067 A1
(43) Pub. Date: Mar. 6, 2008

(54) System and method for employing targeted marketing campaigns in areas with large transient populations

(76) Inventor: William Brian Ingle, Lake Wylie, SC (US)

Correspondence Address: CLEMENTS WALKER, 1901 ROXBOROUGH ROAD, SUITE 300, CHARLOTTE, NC, 28211, US

(21) Appl. No.: 11/515,701

(22) Filed: Sep. 5, 2006

(51) Int. Cl. G06K 5/00

(52) U.S. Cl. 235/380

(57) ABSTRACT

A unique identifier is given to the customers of a primary merchant. The unique identifier suggests to the customer various secondary merchants within or around the community. Incentives at the secondary merchants can also be offered through use of the unique identifier. Purchases made by the customer at the secondary merchant using the unique identifier are recorded in a database for marketing analysis and possible remuneration to the primary merchant. The unique identifier can be returned to the primary merchant for reuse with a different customer.

### BACKGROUND OF THE INVENTION

1. Field of the Invention

The invention is related to systems and methods for conducting a targeted marketing and advertising campaign. Specifically, the current invention is related to these systems and methods in communities such as vacation, coastal, and mountainous communities that have a high transient population, or frequent turnovers in that population. The present invention utilizes unique identifiers given to customers of a primary merchant for a set duration. The unique identifier suggests to the customer various secondary merchants within or around the community and offers incentives from the secondary merchant to the customer.

2. Prior Art

Frequent buyer cards for grocery stores, drug stores and other merchants are well known devices of tracking customer information and buying habits. Each customer is provided with a unique account number. Items that the customer purchases are then linked to the unique account number and stored in a database. The database is generated based on a consumers prior purchases linked to the unique account number. From this data tracking method, targeted marketing campaigns are formulated, where certain incentives are provided to the customers whose purchasing history most closely matches the targeted consumer of the marketed product. By targeting the customers most likely to purchase the advertised products, a merchant can make more effective use of each advertising dollar.

U.S. Pat. No. 5,809,481 issued to Baron et al. discloses a method and system that provides advertisers with a marketing database of potential consumers. A promotional tag is distributed to potential consumers. The consumer then attaches the tag to a piece of personal property, such as a briefcase. The consumer registers the tag with a processing facility that creates a master database comprising the consumer's tag identifier and contact information. The master database serves as a directory to return the personal property to the consumer if the property is lost. Information from the database can also be extracted to generate a marketing database for potential advertisers.

U.S. Pat. No. 6,070,147 issued to Harms et al. discloses a method and system for administering a loyalty marketing program. Government issued identification cards such as a driver's license are utilized as the frequent buyer redemption cards. Data from the cards are used to gather further information or demographics from third party databases. Incentives based on use of the cards are also disclosed.

U.S. Pat. No. 6,360,167 issued to Millington et al. discloses a GPS based vehicle navigation system including multimedia advertisements. Ads corresponding to the current location of the vehicle periodically appear on a screen. If interested, the user can request additional information about the ad. The additional information may be transmitted to the vehicle via a removable media reader, or through a wireless communication system on the vehicle.

U.S. Pat. No. 6,988,658 issued to Smith discloses a system for facilitating a transaction between a merchant and a consumer. A consumer interface emits an identity signal, which is received by a settlement administrator. The settlement administrator then facilitates payment between an account of the consumer, and an account of the merchant. An incentive administrator may also be included for providing incentives to the customer.

Targeted marketing campaigns are most effective with a population of repeat customers so that the database builds a detailed record of each customer and the buying habits of each. Targeted marketing campaigns are generally not as effective in an area where there is a large seasonal, transient, or temporary population, such as many vacation towns or coastal and mountain communities. In many of these areas, there is a total population turnover from week to week. Attempting a targeted marketing campaign for such a population would result in a database very shallow on information. Individual customers would not reside nearby long enough to result in any meaningful data collected. Furthermore, any incentive provided would be sent to customers that had long since departed the merchant's effective geographic location.

Thus there is a need for a targeted marketing and advertising system that can work effectively in areas of high transient populations.

### SUMMARY OF THE INVENTION

For the purposes of the present invention, merchants in vacation areas can be classified into primary and secondary merchants, based on when a customer comes in contact with the merchant. Primary merchants include those companies such as hotels, motels, rental properties, car rentals, and other merchants that are typically the first or one of the first contacts a consumer has when entering the vacation area. While the majority of business transactions by a primary merchant will generally be targeted at transient customers, such a demographic breakdown is not the sole basis of determining a primary merchant.

Secondary merchants, on the other hand, include each merchant that is not classified as a primary merchant. It can include, but is not limited to, grocery stores, souvenir shops, entertainment facilities—such as a movie theater, theme park, golf course, etc.—as well as guide services, restaurants, and rental equipment.

For purposes of the present invention, a “population turnover” is defined as the period during which the customer uses the goods or services provided by the primary merchant. By way of a non-limiting example, if the primary merchant is a rental car company, the population turnover would be the duration of the rental car agreement for a customer.

The recent invention relates to an advertising system and method, as well as a system and method for a targeted marketing campaign that is useful in areas with large and frequent population turnovers. The present system and method assumes various common activities associated with the transient population and uses these commonalties as the basis for the targeted advertising and marketing campaigns.

Upon the purchase or acquisition of goods or services from a primary merchant, the customer is provided with a unique account identifier. The identifier itself is associated with the primary merchant and not the customer, so that the same unique identifier can be reused after a population turnover.

The unique account identifier contains indicia that suggests to the customer one or more secondary merchants, including possible promotional incentives.

When the customer makes a purchase at one of the suggested secondary merchants, the unique identifier, as well as a variety of purchase information, is recorded into a database. From this the secondary merchant can quantify the sales volume and inventory due to the transient population. Further, the merchant can tailor his inventory, pricing, and incentives to better serve the needs of these transient customers.

Additionally, the database can track the primary merchant associated with the unique identifier. Optionally, royalty payments can be made from the secondary merchant to the primary merchant based on sales by the secondary merchant that are attributed to unique identifiers associated with the primary merchant.

It is thus an object of the invention to provide a targeted marketing system that will provide information regarding the spending habits of transient persons in primarily vacation and resort communities.

It is further an object of the invention to provide a targeted marketing system that will allow merchants within these vacation and resort communities to adjust their inventories and advertising to better cater to the transient population within these communities.

It is a further object of the invention to provide a system of advertising that will direct transient persons within the targeted vacation and resort communities to participating merchants.

It is an optional further object of the invention to provide payments (such as royalty payments) to primary merchants for successfully steering customers through the invented advertising and targeted marketing campaign to secondary merchants within these vacation and resort communities. Payments can also be made to a third party marketing facilitator.

The various features of novelty which characterize the invention are pointed out with particularity in the claims annexed to and forming a part of the disclosure. For a better understanding of the invention, its operating advantages, and specific objects attained by its use, reference should be made to the drawings and descriptive matter in which there are illustrated and described preferred embodiments of the invention. It should be recognized by those skilled in the art that the specific embodiments disclosed herein may be readily modified for carrying out the same or similar purposes as that of the present invention. Such equivalent constructions should not be deemed to depart from the spirit and scope of the present invention as set forth in the appended claims.

### BRIEF DESCRIPTION OF THE DRAWINGS

The present invention is further described in detail below with reference to the accompanying drawings, in which:

FIG. 1 illustrates a high level block diagram flowchart of a preferred embodiment of the described method;

FIG. 2 illustrates a high level block diagram flowchart of the interaction between the unique identifier and the local database during presentation of the unique identifier.

### DETAILED DESCRIPTION OF THE PREFERRED EMBODIMENTS

When vacationing persons (customers) arrive at their destination, there is a general collection of common services that the vast majority of these customers will acquire. For the purposes of the invention, the common services are collectively referred to as “primary merchants.” The ideal primary merchant would be one that every incoming traveler, or a large percentage of those travelers, has some initial contact with. Usually, the primary merchant is the first, or one of the first services a customer will seek out when arriving at the destination. By way of non-limiting example, primary merchants can include companies such as hotels, motels, single and multiple family rental properties, car rentals, and other merchants. Additionally, a primary merchant can even be an airline, bus, train, or other transit company that the customer utilizes to arrive at his destination.

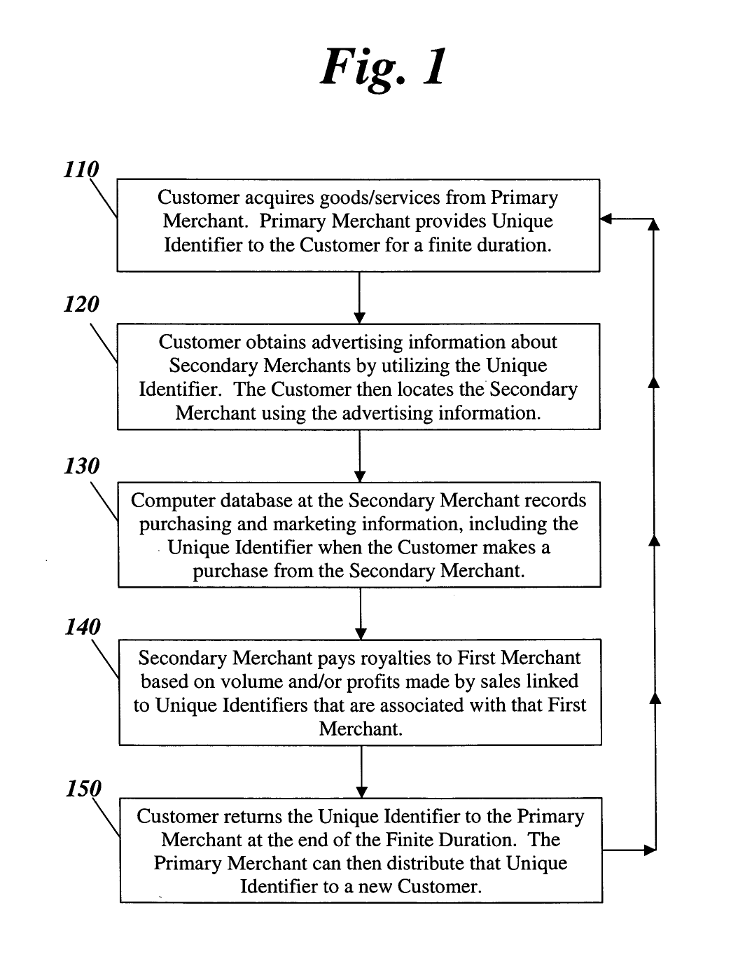

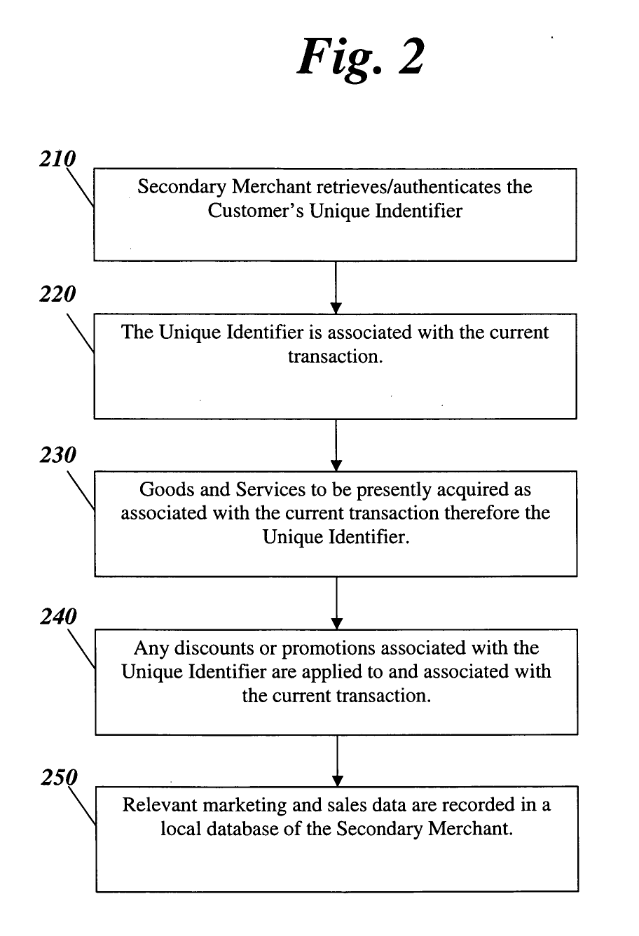

Referring now to FIGS. 1 and 2, upon acquiring services from the primary merchant, the customer is provided with a unique identifier 110 (FIG. 1). The unique identifier is preferably a machine readable code, such as an alphanumeric code, a bar code, a serial number, an RFID tag, IRID tag, magnetically readable data, or digitally stored data.

It should also be noted that use of the unique identifier is tied to the duration of use of the goods and services provided by the primary merchant. For the case of rental property, hotels, rental cars, and the like, this finite duration is generally the length of the rental contract. In the case of airline, bus, train, or other transit companies, the finite duration is defined differently. For primary merchants who are not involved in business within the community, but rather are responsible for transporting customers to or from the community, the finite duration can be defined as the length of time between arriving at and departing from the community. Alternatively for primary merchant transit companies, the finite duration can be defined as the time between successive uses of the goods or services provided by the primary merchant—such as the case of a round-trip airline ticket.

Optionally, the primary merchant can report acquisition of the primary good and the corresponding unique identifier to a third party marketing facilitator for tracking of the unique identifier and any subsequent usage thereof. The marketing facilitator can then record the unique identifier and the associated limited duration in a marketing facilitator database.

The unique identifier can be contained in or on a key fob, a pin, a bracelet, a necklace, a badge, a card, a patch, or any similar easily carried item. The unique identifier is preferably small enough to carry in a wallet, purse, or pocketbook, or attached to a keychain. The unique identifier can be produced as a reusable or disposable item.

The unique identifier is provided with advertising and/or promotional indicia thereon. The indicia is used to communicate or suggest to the customer the location and services provided by a secondary merchant. The indicia can be a telephone number, an Internet address or website, or simply the name and address of a secondary merchant. This is depicted in block 120 of FIG. 1.

When the indicia is a phone number, or website, the customer can connect to a stored database of secondary merchants by utilizing the number or address suggested by the indicia. The stored database provides a listing of secondary merchants that are affiliated with the targeted marketing and advertising system of the present invention. The listing of secondary merchants can further be broken into categories, such as, but not limited to, restaurants, entertainment venues, amusement parks, grocery stores, recreational rental facilities, movie theaters, and other various attractions. From the database, the customer can select a desired secondary merchant and additionally obtain information on the type of services provided by the secondary merchant, the location of and general directions to the secondary merchant, as well as any discounts affiliated with the unique identifier that are currently being offered by the secondary merchant.

The database can be stored on a computer and accessed via a customer interface, which can include numeric keypad inputs or voice commands when the customer connects to the database via a telephone, or alphanumeric inputs or icon selection when the customer connects to the database via a computer or Internet connection.

In the case of rental cars, the stored database can be provided as a personal digital assistant (PDA) type device that is permanently mounted inside the vehicle. The customer can use the unique identifier to interact with the PDA. Information about secondary merchants can then be retrieved from a stored database within the PDA. Optionally, the PDA can include a global positioning system (GPS) module. When a GPS is included in the PDA, the customer can optionally search and sort the secondary merchants based on the current proximity of the secondary merchants to the GPS enabled PDA.

If the indicia are simply the names of secondary merchants, then directions to the secondary merchants, a physical address and/or a telephone number of the secondary merchants are also preferably provided.

Any goods or services acquired by the customer at the secondary merchant are associated with the unique identifier, as shown in block 130. Upon making a purchase at a suggested secondary merchant, the customer presents the unique identifier to the secondary merchant, as shown in block 210 of FIG. 2. Presentation of the unique identifier can be made in a variety of ways and is not intended to be a limiting feature of the invention. Presentation made by inputting the unique identifier into a local secondary database of the secondary merchant. This can be accomplished either actively by scanning a barcode, alphanumeric code, magnetically readable media, digital media, and the like, or passively, such as through the acquisition of data by radio frequency or infrared identification cards—RFID and IRID cards respectively. Passive presentations have the advantage of being able to track not only purchases associated with the unique identifier, but also non-invasively track store traffic by customers carrying the RFID and IRID cards.

The unique identifier is then associated with the current transaction, as well as the goods and services acquired from the secondary merchant in the local secondary database, as shown in FIG. 2, blocks 220 and 230. Any discounts associated with the use of the unique identifier are applied at this time, as shown in block 240. Unique identifiers that are also associated with the primary merchants are assumed to be utilized by transient persons. Data from acquisitions related to these unique identifiers can be segregated out from other transactions of the secondary merchant. Because the unique identifier is associated with the primary merchant and not with the transient customer, the secondary merchant can accumulate data about the general spending habits of customers in a market area with large transient populations. Heretofore, merchants had no direct effective way of tracking the amounts and identity of items purchased by transient customers. By associating the unique identifier provided by a primary merchant with the purchases of the customer, the secondary merchant can then tailor his services and inventories to better match the needs and spending trends of the transient population.

Discounts and other incentives can optionally be offered to the customer by the secondary merchant for purchases made with utilizing the unique identifier. Any incentive that was taken advantage of by the customer can also be stored in the local secondary database.

The local secondary database is able to track purchases by consumers who use their assigned unique identifier, as shown in FIG. 2, block 250. Because each unique identifier is associated with a specific primary merchant, the secondary merchants are able to attribute sales and store traffic to a specific primary merchant.

Optionally, the limited duration can be encoded onto or electronically associated with the unique identifier. The limited duration can then be acquired by the secondary merchants during presentation of the unique identifier. By tracking the limited duration of the unique identifier, and recording each date of purchase, secondary merchants can determine how many times a particular customer, and not just the unique identifier, frequented the secondary merchant during the limited duration. This can provide the secondary merchant with information regarding repeat visits of customers.

Furthermore, data that is recorded into each local secondary database can optionally be communicated back to the primary merchant and or the marketing facilitator for recordation in either the marketing facilitator database, or a primary merchant database. Data can then be compiled into a conglomerate report for distribution among secondary merchants. By tracking the limited duration associated with each unique identifier, the marketing facilitator or primary merchant could provide to each secondary merchant a listing of other secondary merchants that a customer visited while in possession of the unique identifier.

Communication of the recorded secondary database data to the primary merchant or the marketing facilitator can be made by a printed hardcopy, or preferably communicated through an electronic network such as the Internet, a private network, an Ethernet, or other direct or indirect electronic connection.

Optionally, remuneration can then be made from the secondary merchant, either directly or indirectly, to the primary merchant, based on the sales volume and store traffic that is attributed to the primary merchant through use of the unique identifiers, as shown in FIG. 1, block 140. As purchases are made, the items, their costs, any incentives, as well as other information, such as profits, losses, remaining inventory etc. is entered into the secondary database. Each of these purchases made by a customer using a unique identifier is cross referenced in the local secondary database with that unique identifier. Because each identifier is specific to a certain primary merchant, the sales and store traffic of a secondary merchant can be directly linked to a specific primary merchant by cross referencing the unique identifier.

An optional compensation arrangement can then be set up between the secondary merchant and the primary merchant for increased sales and/or store traffic that are attributable to the suggestions of the unique identifiers associated with that primary merchant. Payments can be made either directly to the primary merchant, or to a facilitator who takes in payments from the secondary merchants and then compensates the primary merchants for the increased traffic and sales to the secondary merchant.

Furthermore, payments, such as royalty payments, can optionally be made by either of the primary merchant, or the secondary merchant to the Marketing Facilitator. Payments made to a Marketing Facilitator from a Secondary Merchant can be provided based on the similar conditions as payments from a secondary merchant to a primary merchant, described above. Payments made from a primary merchant to the marketing facilitator can be based on the ability to promote and utilize the invented marketing campaign. Payments from the primary merchant to the marketing facilitator can therefore be lump-sum payments, or be royalty based.

At the conclusion of the limited duration, the customer returns the unique identifier to the primary merchant, according to block 150. Because the unique identifier is associated with the primary merchant, and not to the customer, it is not necessary to reprogram the identifier. The unique identifier is immediately ready for distribution to a subsequent customer.

Thus it is apparent that there has been provided in accordance with the invention, a targeted marketing and advertising system capable of effective marketing and advertising of local merchants in predominantly transient communities. The invention also provides methods and systems for tracking the purchases at these local merchants by transient customers, and provides a system and method for compensating those who refer the customers to the local merchants. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

I claim:

1. A method of advertising and tracking marketing data, said method comprising:
a. providing to a customer from a primary merchant, a unique identifier, said unique identifier being associated with said primary merchant, and having indicia thereon;
b. utilizing said indicia and suggesting to said customer a secondary merchant;
c. acquiring products or services by said customer from said secondary merchant;
d. associating said unique identifier with purchase information recorded at said secondary merchant, for acquisitions made by said customer;
e. recording at least one of said purchase information or said unique identifier into a computer database.

2. The method of claim 1, wherein said primary merchant is selected from the group consisting of hotels, motels, single family rental properties, multiple family rental properties, and car rental agencies.

3. The method of claim 2, wherein said primary merchant is a rental car agency.

4. The method of claim 1, wherein said unique identifier is selected from the group consisting of alphanumeric codes, bar codes, RFID tags, and magnetically readable data.

5. The method of claim 1, wherein said unique identifier is contained on a key fob, or a card sized to fit in a wallet or pocketbook.

6. The method of claim 1, wherein said indicia comprises the name of said secondary merchant.

7. The method of claim 6, wherein said indicia further comprises the address and phone number of said secondary merchant, and optionally a description of the goods or services offered by said secondary merchant.

8. The method of claim 1, wherein said indicia comprises a telephone number or an Internet address.

9. The method of claim 8, wherein utilizing said indicia further comprises connecting through said telephone number, internet address, or PDA database to a listing that provides information on said secondary merchant.

10. The method of claim 9, wherein said suggesting to said customer further comprises selecting said secondary merchant from said listing.

11. The method of claim 1, wherein said purchase information comprises at least one of the identity of said product or service, the price of said product or service, and quantity of said product or service.

12. The method of claim 1, further comprising the step of
f. determining a sales volume by said secondary merchant that is associated with said unique identifier.

13. The method of claim 12, further comprising the step of
g. optionally providing compensation from said secondary to said primary merchant based on said sales volume that is associated with said unique identifier associated with said primary merchant.

14. The method of claim 1, further comprising the step of:
f. providing an incentive from said secondary merchant to said customer when said customer makes a purchase utilizing said unique identifier.

15. The method of claim 1, further comprising the step of
f. communicating to a marketing facilitator at least one of said unique identifier, and said purchase information.

16. A system for advertising and tracking targeted marketing data in areas having a high frequency of population turnovers, said system comprising:
a. a unique identifier associated with a primary merchant, said unique identifier having indicia thereon;
b. a primary product or service acquired by a customer, wherein said unique identifier is provided to said customer with an acquisition of said primary product or service.
c. a listing of secondary merchants, said listing being accessible by utilizing said indicia;
d. a database for recording at least one of said acquisitions and the associated said unique identifier of a consumer at one of said secondary merchants, using said unique identifier;

17. The system of claim 16, wherein said primary merchant is selected from the group consisting of hotels, motels, single family rental properties, multiple family rental properties, and rental car agencies.

18. The system of claim 17, wherein said primary merchant is a rental car agency.

19. The system of claim 16, wherein said unique identifier is selected from the group consisting of alphanumeric codes, bar codes, RFID tags, and magnetically readable data.

20. The system of claim 16, wherein said unique identifier is contained on a key fob, a pin, a bracelet, a necklace, a badge, a card, or a patch.

21. The system of claim 16, wherein said indicia comprises at least one of a name of said secondary merchant, an address of said secondary merchant, a phone number of said secondary merchant, and a description of the goods or services offered by said secondary merchant.
